(19) United States
(12) Patent Application Publication
(10) Pub. No.: US 2010/0161690 A1
(43) Pub. Date: Jun. 24, 2010

(54) FILE RETRIEVAL SYSTEM AND ELECTRONIC DEVICE USING THE SAME

(75) Inventor: YI-TA CHIANG-LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/430,054

(22) Filed: Apr. 24, 2009

(30) Foreign Application Priority Data
Dec. 24, 2008 (CN) 200810306513.X

(51) Int. Cl. G06F 12/02; G06F 12/00

(52) U.S. Cl. 707/822; 711/170; 711/E12.001; 711/E12.002

(57) ABSTRACT

A file retrieval system for a memory device includes a reserved area and a plurality of clusters. A file is divided into a number of sections scattered on the clusters. The file retrieval system includes a write unit, a record unit, and a restoration unit. The write unit writes sections to the clusters. The record unit is for recording section allocation information of the sections to the reserved area, simultaneously during writing of the sections of the file to the clusters. The restoration unit restores data stored in the clusters, according to the section allocation information in the reserved area.

### BACKGROUND

1. Technical Field

The disclosure relates to file retrieval and, particularly, to retrieval of files from a memory device and an electronic device using the same.

2. Description of Related Art

Memory devices, widely used in electronic devices such as cameras, often include a number of clusters and a file allocation table (FAT). A file may be divided into many sections scattered around the clusters. The FAT records locations of file portions in associated clusters, but is updated only when the electronic device is shut down normally. One danger inherent with such a memory device is that accidental shutdown during writing to a file may result in failure to retrieve any data input in the future since the last FAT has not been update.

Therefore, what is desired is a file retrieval system and an electronic device using the same that can overcome the described limitations.

### BRIEF DESCRIPTION OF THE DRAWINGS

FIG. 1 is a schematic diagram of a memory device including a file retrieval system, in accordance with one exemplary embodiment.

FIG. 2 is a functional block diagram of the file retrieval system of FIG. 1, in accordance with one exemplary embodiment.

### DETAILED DESCRIPTION

Embodiments of the present file retrieval system will now be described in detail with reference to the drawings.

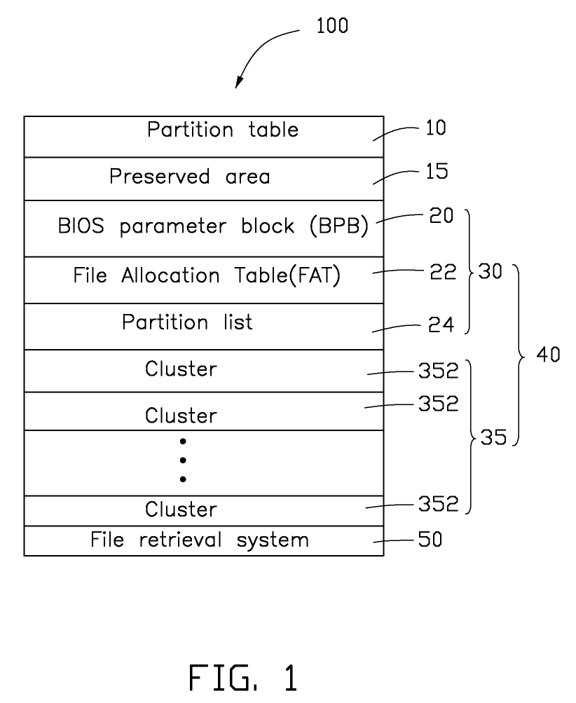

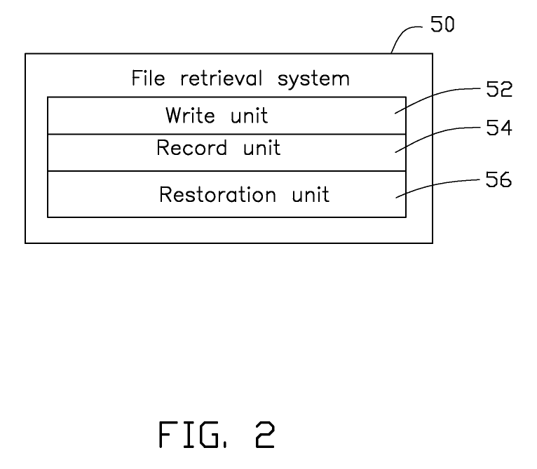

Referring to FIGS. 1-2, a memory device 100, according to an exemplary embodiment, includes a partition table 10, a reserved area 15, and a partition 40. The memory device 100 can be a movable hard disk, a flash memory, or a SD card, and can be applied to portable electrical devices, such as cameras, or camcorders.

The partition table 10 contains partition information such as the number, size, and physical locations of the partition 40 and, if any, other partitions (not shown).

The partition 40 includes a partition information table 30 configured for recording storage information of the partition 40, and a partition storage area 35 configured for storing file(s), such as image file or video file. The physical locations of the partition information table 30 and the partition storage area 35 are continuously and sequentially distributed.

The partition information table 30 includes a BIOS parameter block (BPB) 20, a File Allocation Table (FAT) 22, and a file list 24. The BPB 20 records the size of the partition 40. The FAT 22 includes a vector table of the physical locations and corresponding logical locations of the sections of the files stored in the partition 40. The vector table of the physical locations of the FAT 22 is updated when the memory device 100 is shutdown normally. The file list 24 records a list of the files stored in the partition 40.

The partition storage area 35 includes a number of clusters 352. The physical locations of the clusters 352 are sequentially distributed in the partition storage area 35. In this embodiment, the storage capacity of each cluster 352 is 4096 bytes.

The reserved area 15 functionally connects the partition table 10 and the partition 40 and is reserved for potential use.

In this embodiment, the memory device 100 further includes a file retrieval system 50. The file retrieval system 50 includes a write unit 52, a record unit 54, and a restoration unit 56. The write unit 52 is configured for writing the sections of the file to the clusters 352. The record unit 54 is configured for recording section allocation information of the sections to the reserved area 15 simultaneously during writing of the sections of the file to the clusters 352. The restoration unit 56 is configured for restoring the file stored in the clusters 352, according to the section allocation information recorded in the reserved area 15.

In detail, when the write unit 52 writes sections of a file to clusters 352, the record unit 54 simultaneously records section allocation information of the sections to the reserved area 15, in a form of, for example, a vector table of the physical location of the clusters 352 storing the sections of the file. If the electronic device is accidently shut down during file writing to the memory device 100, after reboot, the sections of the file can be retrieved based upon the allocation information stored in the reserved area 15.

It should be note that the file retrieval system 50 is not limited by this description, and can be configured depending on requirements. In other alternative embodiments, the file retrieval system 50 can also be installed on the electronic device (not shown) using the memory device 100.

It will be understood that the above particular embodiments and methods are shown and described by way of illustration only. The principles and the features of the disclosure may be employed in various and numerous embodiments thereof without departing from the scope of the invention as claimed. The described embodiments illustrate but do not restrict the scope of the invention.

What is claimed is:

1. A file retrieval system applied on a memory device, the memory device comprising a reserved area and a plurality of clusters which a file saved in the memory device is divided into a plurality of sections scattered on the clusters, a file allocation table (FAT) comprising a vector table of the physical locations of the sections of the file stored in the clusters, the file retrieval system comprising:
a write unit configured for writing the sections of the file to the clusters of the memory device;
a record unit configured for recording section allocation information of the sections to the reserved area simultaneously with the writing of the sections to the file; and
a restoration unit configured for restoring the data stored in the clusters, according to the section allocation information in the reserved area.

2. The file retrieval system as claimed in claim 1, wherein the storage capacity of a cluster is 4096 bytes.

3. The file retrieval system as claimed in claim 1, wherein the memory device is applied to a camera, or a camcorder.

4. The file retrieval system as claimed in claim 1, wherein the file is an image file or video file.

5. The file retrieval system as claimed in claim 1, wherein the memory device is a movable hard disk, a flash memory or a SD card.

6. An electronic device, comprising:
a memory device comprising:
a plurality of clusters configured for storing a plurality of sections of a file;
a reserved area; and
an file retrieval system comprising:
a write unit configured for writing the sections of the file to the clusters of the memory device;
a record unit configured for recording section allocation information of the sections to the reserved area simultaneously during writing of the sections of the file; and
a restoration unit configured for restoring the stored in the cluster, according the section allocation information in the reserved area.

7. The electronic device as claimed in claim 6, wherein the memory device further comprises a partition table and a partition comprising plurality of clusters, the partition table contains partition information of the partition.

8. The electronic device as claimed in claim 7, wherein the partition further comprises a File Allocation Table (FAT) comprising a vector table of the physical locations of the sections of the file stored in the plurality of clusters.

9. The electronic device as claimed in claim 7, wherein the partition further comprises a partition information table configured for recording storage information of the partition, and a partition storage area, in which the clusters are set.

10. The electronic device as claimed in claim 9, wherein the partition information table comprises a file list configured for recording a list of the files stored in the partition.

11. The electronic device as claimed in claim 6, wherein the reserved area connects the partition table and the partition and is reserved for potential use.

12. The electronic device as claimed in claim 6, wherein the storage capacity of a cluster is 4096 bytes.

13. The electronic device as claimed in claim 6, wherein the memory device is applied to a camera, or a camcorder.

14. The electronic device as claimed in claim 6, wherein the file is an image file or video file.

15. The electronic device as claimed in claim 6, wherein the memory device is a movable hard disk, a flash memory, or a SD card.
